(19) United States
(12) Patent Application Publication
(10) Pub. No.: US 2016/0278444 A1
(43) Pub. Date: Sep. 29, 2016

(54) SMART CLOTHING

(71) Applicant: Intel Corporation, Santa Clara, CA (US)

(72) Inventors: Adam Jordan, El Cerrito, CA (US); Rita H. Wouhaybi, Portland, OR (US); John C. Weast, Portland, OR (US); Joshua Ratcliff, San Jose, CA (US)

(21) Appl. No.: 14/667,165

(22) Filed: Mar. 24, 2015

(51) Int. Cl. A41D 1/00; A41D 27/28; G05B 13/04; A41D 13/002

(52) U.S. Cl. CPC A41D 1/002; A41D 13/002; A41D 27/28; G05B 13/048

(57) ABSTRACT

Various systems and methods for implementing smart clothing are described herein. A wearable system for implementing smart clothing comprises a sensor module to receive sensor data from a sensor of the wearable system; a state module to use the sensor data to construct a comfort state of a user of the wearable system; a context module to determine a context of the comfort state; an access module to access a comfort model of the user, the comfort model reflecting target comfort states for associated contexts; and an actuation module to initiate actuators in the wearable system based on the comfort model, the comfort state, and the context of the comfort state.

### TECHNICAL FIELD

Embodiments described herein generally relate to electronic textiles and in particular, to a system for smart clothing.

### BACKGROUND

Electronic textiles (e-textiles) are fabrics that include digital components, such as sensors, microcontrollers, or actuators. E-textiles include any type of fabric used in various contexts, such as blankets or window coverings. Smart clothing is a subset of e-textiles.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system for implementing smart clothing, according to an embodiment;

FIG. 2 is a schematic diagram illustrating a wearable system, according to an embodiment;

FIG. 3 is a block diagram illustrating a wearable system for implementing smart clothing, according to an embodiment;

FIG. 4 is a flowchart illustrating a method of implementing smart clothing, according to an embodiment; and

FIG. 5 is a block diagram illustrating an example machine upon which any one or more of the techniques (e.g., methodologies) discussed herein may perform, according to an example embodiment.

### DETAILED DESCRIPTION

Systems and methods described herein provide a system for smart clothing. The most technologically advanced clothing available to consumers today provides comfort to wearers passively or through manual manipulation. For example, clothing may incorporate openings or mesh for airflow or vents with zippers or other fasteners that may be opened and closed by the wearer. Clothing may also be made out of technical materials such as GORE-TEX® that provide water resistance or “breathability” passively through the properties of the woven fibers. However, clothing with these features only provides comfort within a fairly narrow range of temperatures and conditions. Also, adjustments to the clothing to improve comfort must be done manually by the wearer, interrupting the wearer from his or her current activity. These manual adjustments are imprecise, requiring the wearer to continually make readjustments to maintain comfort as their activities change and external conditions and temperatures change.

This system described a “smart clothing” system that uses sensors, data analytics, predictive algorithms, personal profiles, and actuators in clothing to dynamically change the comfort (e.g. warmth, coolness, and breathability) of clothing, both proactively and in real time. This smart clothing may provide personalized, immediate comfort to the wearer in a broad range of temperatures or conditions. It may react to the wearer's body temperature much more quickly than clothing made from passive materials and adjust using predictive and personalized technologies.

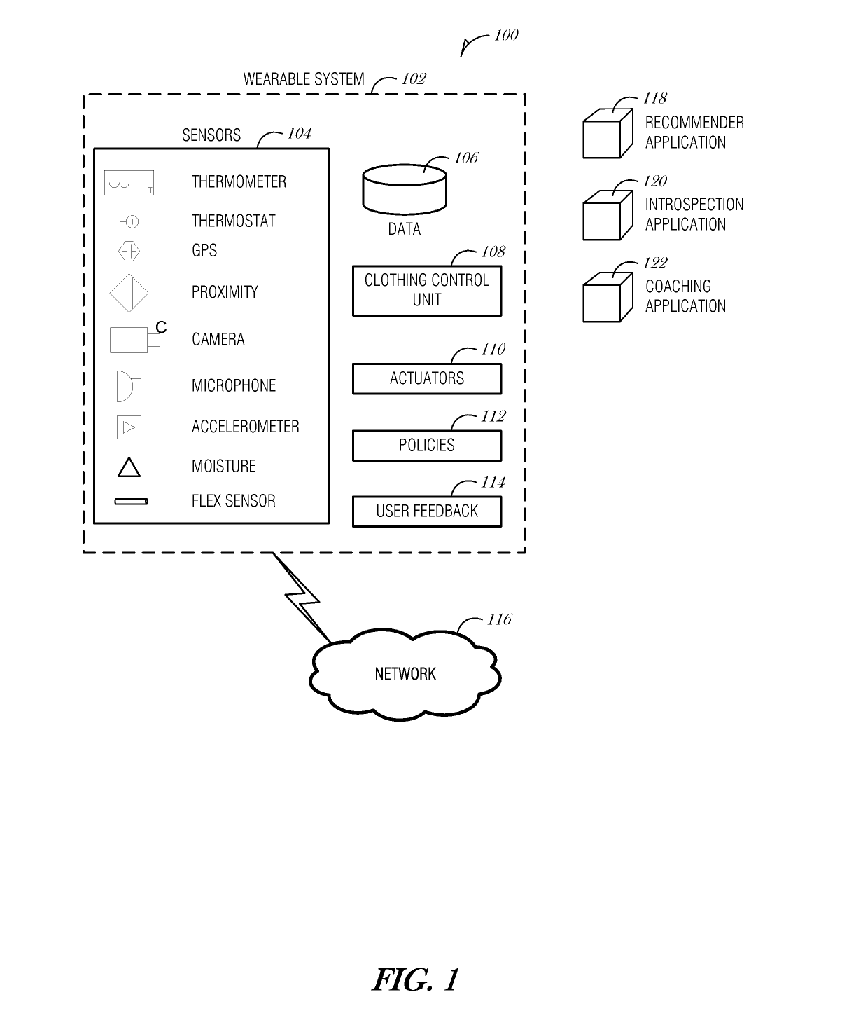

FIG. 1 is a schematic drawing illustrating a system 100 for implementing smart clothing, according to an embodiment. The system 100 includes a wearable system 102 having sensors 104, a data storage 106, and a clothing control module (CCM) 108 to control one or more actuators 110. The CCM 108 may access sensor data provided by the sensors 104, use historical data or other contextual data retrieved from the data storage 106, and based on policies 112, adjust one or more actuators 110 in the wearable system 102. The actuators 110 may be mechanical, electromechanical, or chemical, and may act to modify ventilation, insulation, heating, or other environmental modifications to the clothing worn by the user.

The sensors 104 may include various types of sensors that may be embedded in the wearable system 102 or accessible by the wearable system 102. Sensors 104 may include, but are not limited to a thermometer to sense ambient temperature, body temperature, or the like; a thermostat to adjust heating or cooling mechanisms based on a target temperature; a positioning system (e.g., Global Positioning System) to sense location; a proximity sensor; a camera; a microphone to sense ambient noise, user vocal commands, or the like; an accelerometer to sense user motion; a moisture sensor to detect ambient humidity, perspiration, or the like; or a bend fiber, flex sensor, or piezoelectric material to detect deflection or deformation. It is understood that other sensors may be implemented in the wearable system 102 or accessed by the wearable system 102.

Sensor data gathered by the sensors 104 may be stored in the data storage 106. The data storage 106 may be any type of persistent storage, such as magnetic storage, optical storage, or flash memory storage. The data storage 106 may also store policies 112, configuration information, user preferences, or other operational data for the wearable system 102.

The wearable system 102 may include one or more wearable devices, such as a smart shirt with smart glasses, a watch and smart pants, or other combinations. The wearable system 102 includes at least one wearable device that is able to heat, cool, ventilate, or otherwise adjust a wearer's comfort. Such a wearable device may be an e-textile, such as a smart shirt, smart jacket, smart shoes, or the like.

The wearable system 102 uses information from three sources: 1) sensed data from smart clothing as well as other wearable devices in the wearable system 102 (e.g., a mobile phone, smart glasses, shoe insert, etc.), 2) external environmental conditions around or near the wearer, and 3) personal preferences. The wearable system 102 uses this information to predict and optimize the level of comfort for the user and acts on the information by adjusting the clothing.

The sensed data may be obtained from the sensors 104, which may include temperature, humidity, moisture, barometric sensors; biometric sensors such as heart rate monitors or galvanic skin response to measure body temperature or blood pressure; or accelerometers or flex sensors to measure the movement of clothing. The sensor data may be used to infer the user's current health, state of wellness, or level of fitness, allowing the wearable system 102 to incorporate the user's biometric information into a comfort model. The comfort model may be used to analyze and predict the user's comfort level and adjust clothing in anticipation of the user's needs.

External environmental conditions may be conditions immediately around the user (e.g., in the same room or directly proximate to the user), or near the user (e.g., in an adjacent room, outdoors when the user is indoors, etc.). Information about the external environment may be sensed or obtained through cloud services. This may include real time measurements from locations that the user has not yet entered but is likely to enter based on the user's current location (e.g. the user is outside on a hot day but about to enter an air conditioned building). Information may also be obtained from other users that have sensors embedded in mobile devices, wearable devices, or the like. External environmental conditions may also be crowd-sourced in real-time across large groups of people in the spaces around the user.

Personal preferences may be obtained directly or indirectly from the user. For example, the wearable system 102 may utilize information entered manually by the user on an interface, such as a mobile phone or another wearable computing device, or on the article of clothing itself. The manually-entered information may describe the user's current or desired level of comfort, expected changes in physical activity or location, or feedback on the way the clothing is currently configured. The information may be entered using any modality supported, such as gesture, speech, touch, skin response, embedded buttons or touch panels or strips, or may be displayed on the user's mobile phone or wearable device. Indirect personal preferences may obtained by the user's actions. For example, when the user removes a jacket, manually unzips a jacket or opens a vent, the indirect personal preference gleaned is that the user may be too warm.

As the user provides personal preferences or feedback, user feedback 114 is captured and recorded, such as in the data storage 106. The information about the user (e.g., skin temperature, user preferences) and the external environment (e.g., ambient temperature) may be used in combination with the user's personal comfort profiles (e.g., policies 112) to adjust or manipulate clothing worn by the user.

As information is gathered about the user's body and external environment, it is analyzed to determine an optimal level of comfort for the user. This analysis is achieved through comparing the sensed data to the user's stored usage history and the user comfort profile. The comfort profile allows a highly individualized model of the user's comfort preferences. Additionally, the comfort profile may describe how the user's comfort preferences change over time or are influenced by their context, such as wanting to be warmer when warming up for an exercise routine and cooler during the exercise routine itself. The comfort profile may also describe how the user's comfort preferences change depending on the activity, such as wanting to be warmer during a short sprint but cooler during a long run. Finally, the comfort profile may include information about the user's age, and may adjust the properties of the profile, such as when the user grows older and perceives levels of warmth or coldness differently, when the user has consumed a hot or cold meal or beverage or based on illnesses.

The analysis produces a comfort model, which is a reactive or predictive clothing configuration to adjust a user's clothing in order to move the user's physical state closer to the comfort profile in view of the current conditions.

The clothing may be adjusted using actuators 110, which may be used to increase or decrease air flow between the inside and outside of clothing, tighten or loosen clothing around the wearer's body (e.g., cuffs on a shirt), expand or contract layers of insulation, lengthen or shorten parts of clothing, or convert clothing (e.g., convert a sandal to a shoe). Actuators embedded or woven into the clothing change the characteristics of the clothing to reach the person's optimal comfort level. These actuators may include the following: 1) mechanisms or flexors that open or close vents in the clothing, increasing or decreasing airflow into or out of the clothing, or equalizing the interior temperature and humidity of the clothing in comparison to the outside temperature; 2) mechanisms or flexors that tighten or loosen the clothing, such as around the waist or chest of a jacket, or the sleeves or cuffs of a jacket; 3) tightening or loosening may increase airflow into or out of the clothing; 4) mechanisms that tighten or loosen to increase the current comfort of the wearer by changing in real time based how the clothing is currently being used, based on accelerometers or flex sensors; 5) mechanisms that expand or contract layers of insulation to increase or decrease the warmth of a jacket or pants; 6) mechanisms that lengthen or shorten parts of the clothing, such as sleeves, pant legs, or collars; 7) mechanisms that include chemical-based warmers, such as one-time use warmers; or 8) mechanism that tighten or loosen clothing based on body swelling and/or shrinking. For example, running in humid environments often causes swelling of the hands and feet. The wearable system may loosen or tighten shoes or gloves accordingly for maximum comfort.

Changes to the clothing may be in real time reaction to changing conditions or may utilize predictive modeling to proactively adjust the clothing before the user becomes aware of any discomfort. Predictive modeling may be performed using sensor data or other data obtained over a network 116 from other sources, such as a weather data feed. Sensor data may also be obtained from another device in the wearable system 102. For example, the CCM 108 may be integrated into a smart jacket, which is able to connect to a smart watch to obtain the user's heart rate, skin temperature, and perspiration. Using this biometric data, the CCM 108 may increase or decrease the insulation properties of the smart jacket to ensure that the wearer is comfortable, e.g., when a running jacket senses an increase in the wearer's heart rate, the jacket may proactively open air vents before the user starts to get hot. Any type of wearable or clothing may be controlled or configured by the wearable system 102. For example, jackets, shirts, and pants may include air vents that open or close, layers of insulation that expand or contract, sleeves or pant legs that lengthen or shorten, or collars, cuffs, or waistbands that tighten or loosen. Insulation may be provided with an inflatable bladder to increase the insulative properties.

The wearable system 102 may include one or more user interfaces. The user interfaces may be implemented with various display technologies, such as a display incorporated into a shirt sleeve, on a watch, in a glasses-based device, or the like. Additionally or alternatively, the user interface may be implemented with a projection based mechanism, such as a pico projector implemented on a watch, mobile phone, glasses-based wearable, or the like. Along with using the user interface to configure preferences or provide feedback (e.g., by way of manual clothing configuration, or by answering queries about the user's comfort), the user interface allows the user to view the actual data that the wearable/clothing is generating or receiving, for introspection and monitoring purposes. The user interface may also indicate if the wearable system 102 is operating within the user's comfort profile, or if the external temperature is beyond the capabilities of the wearable system 102 to increase cooling or warmth.

The network 116 may include local-area networks (LAN), wide-area networks (WAN), wireless variant networks (e.g., wireless LAN (WLAN) such as a network conforming to an IEEE 802.11 family of standards or a wireless WAN (WWAN) such as a cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LANs or WANs, such as the Internet. The various devices in FIG. 1 may be coupled to the network 106 via one or more wired or wireless connections.

Other users may connect to the network 116 and obtain personal information about the user. For example, a marketing agency may obtain personal information about the user and their comfort levels and find that the person is rarely warm enough. Using such information, a specialized personal offer may be made to the person for a discount on a warmer jacket. Other users with smart clothing may also provide information, which may be useful to find trends.

The wearable system 102 provides sharing mechanisms to support various usages. The user's comfort data may be shared with other people to compare how similar or different their comfort levels are to people in physical proximity. The comfort data may be shared with health professionals to provide information about the user's current state of health or provide guidance (e.g., coaching). Sharing may also include environmental sensed data such as temperatures inside a building in different locations that would allow the wearable system 102 to proactively optimize the wearable/clothing as the user experiences sudden changes in temperatures while transitioning from one location to another. Data about usability, adjustability, compatibility, reliability, or other aspects of a certain wearable clothing or device may be shared among users. This may provide consumer information to a potential buyer so that they may make their decision about a wearable. Comfort data may also be shared anonymously with other people in proximity, so that their smart clothing can also make comfort adjustments.

Various applications may interface with the wearable system 102. The applications may be hosted on the wearable system 102 (e.g., on a mobile device) or in the cloud (e.g., network 116). A recommender application 118 may be used to recommend certain clothing or wearables to the user based on an anticipated need or context. For example, the recommender application 118 may recommend clothing to a person in a store, or in the morning when getting dressed (forward looking to scheduled events during a day).

An introspection application 120 may provide various historical data views. For example, the introspection application 120 may provide a historical view of use (e.g., how much the user sweat during a day, or how hot/cold the user got over a certain period).

A coaching application 122 may track athletic performance and wearable/clothing configuration to identify trends or provide other analysis. For example, the coaching application 122 may use the sensors 104 to help athletic performance, such as by identifying that personal performance is better when the user is a little hot or cold. The coaching application may recommend/coach the person to use clothing differently based on previous performances and the current environmental conditions.

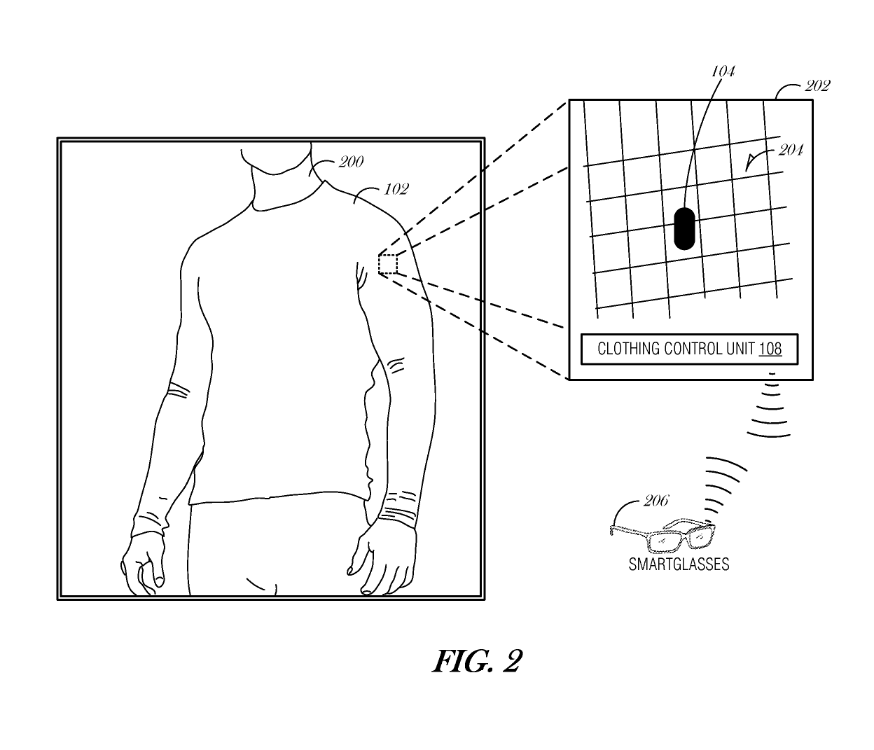

FIG. 2 is a schematic diagram illustrating a wearable system 102, according to an embodiment. FIG. 2 illustrates a user 200, wearing the wearable system 102. In the example shown, the wearable system 102 includes a shirt. It is understood that other forms of wearables or textiles may be used including, but not limited to a scarf, a sleeve, a pant, a dress, a sock, a shoe, an underwear item, or any combination or portion thereof.

An exploded region 202 is shown to illustrate a magnified portion of the wearable system 102. The exploded region 202 is of an e-textile (e.g., smart clothing) and includes the base fabric 204, which may be woven into a textile mesh in a conventional fashion, a sensor 104, and a CCM 108. The base fabric 204 may be any type of fabric, such as cotton, polyester, nylon, or other technical fabrics, such as GORE-TEX®, or combinations or blends thereof. While only one sensor 104 is shown in FIG. 2, it is understood that two or more sensors may be used to detect environmental, biometric, or mechanical states or activity.

The CCM 108 is communicatively coupled to the sensor 104 and is configured to detect the information detected by the sensor 104. The CCM 108 may be wirelessly coupled to one or more sensors 104 to determine body movement, body temperature, air temperature, location, or manipulation of the base fabric 204 and sensor 104. Alternatively, the CCM 108 may be wired directly to one or more sensors 104. Combinations of wired and wireless connections are also considered to be within the scope of the disclosure.

Using the sensor data from the sensor 104, the CCM 108 may communicate raw data or processed data to another device, such as smartglasses 206 worn by the user 200. The smartglasses 206 (or other device) may provide the user 200 a user interface for the user 200 to provide feedback, manually configure clothing options, or the like. While smartglasses 206 are illustrated in FIG. 1, it is understood that any computing device may be used, such as a mobile phone, table, hybrid computer, or the like.

In an embodiment, the wearable system 102 includes a power supply, such as a thermocouple-based power supply, a wireless power supply, or a piezoelectric power supply.

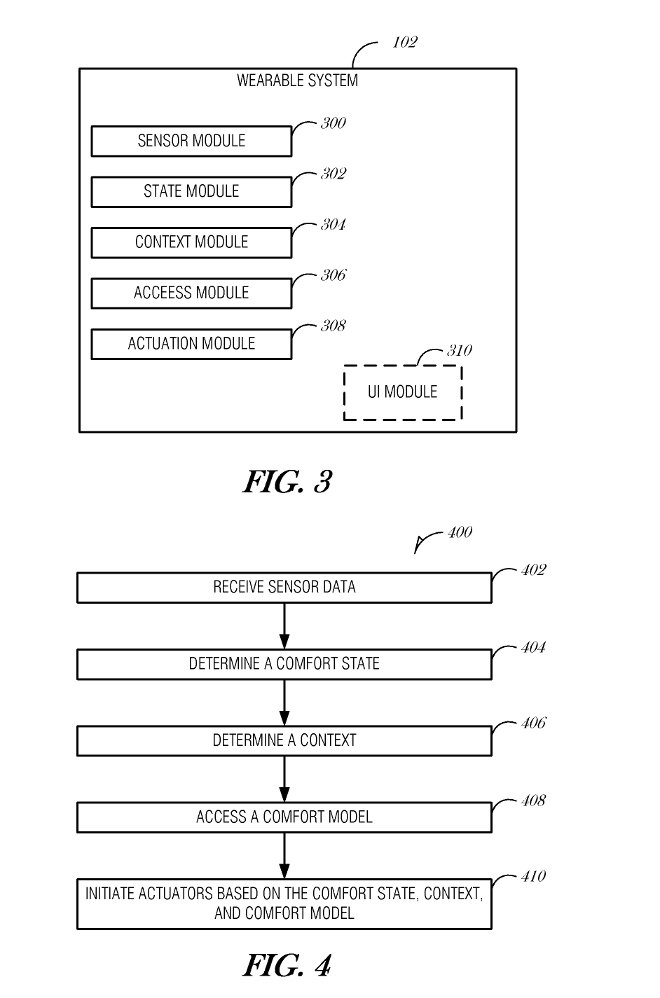

FIG. 3 is a block diagram illustrating a wearable system 102 for implementing smart clothing, according to an embodiment. The wearable system 102 includes a sensor module 300, a state module 302, a context module 304, an access module 306, and an actuation module 308.

The sensor module 300 may be configured to receive sensor data from a sensor of a wearable system. In an embodiment, to receive sensor data, the sensor module 300 is to access a sensor integrated into the wearable system and obtain the sensor data from the sensor integrated into the wearable system 102. Various sensors may be used, such as those described above with respect to FIGS. 1 and 2.

In an embodiment, to receive sensor data, the sensor module 300 is to access a networked sensor and obtain the sensor data from the networked sensor. In a further embodiment, the networked sensor is provided by a cloud-based service. For example, the sensor module 300 may access a weather feed from a cloud-based service to obtain a current temperature in the vicinity of the user.

In another embodiment, the networked sensor is an environmental sensor installed in a location associated with the user. In an embodiment, the location associated with the user is the location of the user. In another embodiment, the location associated with the user is a destination of the user. For example, a thermometer installed in a room may be accessed. The room may be local to the user (e.g., a conference room where the user is currently located) or a remote location (e.g., the user's living room). In addition to location, a user's motion may be obtained (e.g., from a GPS sensor) to determine the user's speed, direction, and map data, in order to anticipate the user's likely future location.

In an embodiment, the networked sensor is a personal sensor of another user. Other user devices nearby the user may be accessed with the permission of the owners of such devices to obtain sensor data from those devices. Such sharing may be performed over a mesh network. As such, comfort data may be shared anonymously with other people in proximity, so that their smart clothing can also make comfort adjustments. As an example, one user walking outside may obtain data from another person who already outside, where the data is used to change the user's clothing using the data from the person who already experienced the outdoor environment.

The state module 302 may be configured to use the sensor data to construct a comfort state of a user of the wearable system. In an embodiment, to use the sensor data to construct the comfort state, the state module 302 is to obtain a biometric value from the sensor data and compare the biometric value to a previously-obtained biometric value of the user. For example, the user's resting heart rate may be obtained and stored. Later, when the user is excited or in a heighten state of awareness, the user's heart rate may be compared to the resting heart rate to construct a current comfort state of the user. In embodiments, the biometric value is one of: a heart rate, a skin temperature, or a skin perspiration level. Biometric information may be used to infer various comfort states of the user.

The context module 304 may be configured to determine a context of the comfort state. The context may include the environmental conditions that the user finds him in (e.g., temperature, raining, humidity, time of day, etc.). In an embodiment, to determine the context of the comfort state, the context module 304 is to use sensor data to obtain an ambient measurement. In further embodiments, the ambient measurement is one of: an ambient temperature, an ambient noise level, or an ambient humidity.

The context may also be related to the user's current location. The location may provide insight into the user's context. For example, when the user is located at a fitness facility, then the user may be inferred to be likely working out or otherwise engaged in an activity. In an embodiment, to determine the context of the comfort state, the context module 304 is to obtain a location of the user from the sensor data and determine the context from the location.

The context may also be related to the user's current activity (e.g., scheduled activity, such as a meeting). In an embodiment, to determine the context of the comfort state, the context module 304 is to access a calendar of the user and determine the context from the calendar. The calendar may be cross referenced with other indicia, such as the user's location, ambient noise, or the like.

The access module 306 may be configured to access a comfort model of the user, the comfort model reflecting target comfort states for associated contexts. In an embodiment, to access the comfort model of the user, the access module is to access the comfort model from a networked storage location. For example, the comfort model may be stored on a network (e.g., in a cloud system), so that the user is able to wear different outfits and have the model available to each of the various outfits. Inversely, a user's various articles of smart clothing may contribute to the single, shared comfort model that may be made available to all smart clothing.

As another example, cloud-based central ‘policy’ enforcement may be used in a building, factory, or other controlled workspace that provides advanced indication of environmental or other context to the user prior to entering the space so the smart clothing can predictively adjust. The policy enforcement may also be used to interact with the wearable system 102 and force the actuation of one or more features, for example for health or safety reasons (e.g., there was an exposed airborne agent that the clothing could protect against by tightening up cuffs).

The actuation module 308 may be configured to initiate actuators in the wearable system based on the comfort model, the comfort state, and the context of the comfort state. In an embodiment, to initiate actuators in the wearable system based on the comfort model, the comfort state, and the context of the comfort state, the actuation module is to initiate actuators using predictive modeling on the comfort model. The predictive model may be based on machine learning techniques that observe user behavior and reaction over time and adjust to fit clothing configuration to the user's preferences.

In embodiments, to initiate actuators in the wearable system based on the comfort model, the comfort state, and the context of the comfort state, the actuation module is to initiate one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction. Such mechanisms may be used to increase or decrease the user's core temperature, skin temperature, perspiration, or the like, to generally increase or improve the user's comfort level.

In a further embodiment, the wearable system 102 includes a user interface module 310 to present a user interface to the user and receive responsive input from the user. The user interface may be presented in various ways, such as with a glasses-based device, a projected screen, a digital or electronic display, or the like.

In an embodiment, the responsive input is used to manually modify a setting of the wearable system. For example, the user may be too hot and desire to immediately shorten the length of the jacket's sleeves. The user may interact with the user interface and manually initiate the actuators in the jacket. Such action may be recorded by the wearable system 102 and incorporated into future predictive modeling.

In an embodiment, the responsive input comprises feedback, the feedback used to modify the comfort model. Feedback may be received after expressly prompting the user. For example, the user may be prompted with “Is the jacket too warm?” or “Are your legs cold?” Feedback may be used to immediately or reactively adjust clothing.

In an embodiment, the responsive input comprises user state information. For example, the user may provide information about the user's current health state, such as the fact that the user is feeling warm because of a fever related to some sickness. This heath information may be used to adjust clothing in a manner that is different than when the user is feeling normal. In embodiments, the user state information includes a user health indication, a user activity indication, or a user location indication. Activity indications may be indications that the user is performing some specific activity, such as running or jogging. In this manner, the user may provide contextual input to help the wearable system 102 to understand the environmental and user contexts. Such input may also be used to confirm sensor data or be used in place of sensor data.

In an embodiment, the responsive input is provided by the user via an implicit indication or an explicit indication. Implicit indications may be based on subconscious actions, such when the user removes their jacket, which may indicate that the user was too warm and wanted to cool down. Explicit indications are purposeful user interactions with the wearable system 102. In embodiments, the explicit indication is one of: an active gesture, an activation of a user interface control, or a verbal command. Gestures or verbal commands may be sensed by the sensors in the wearable system 102, for example.

FIG. 4 is a flowchart illustrating a method 400 of implementing smart clothing, according to an embodiment. At block 402, sensor data is received at a clothing control module of a wearable system. In an embodiment, receiving sensor data comprises accessing a sensor integrated into the wearable system and obtaining the sensor data from the sensor integrated into the wearable system.

In an embodiment, receiving sensor data comprises accessing a networked sensor and obtaining the sensor data from the networked sensor. In a further embodiment, the networked sensor is provided by a cloud-based service. In another embodiment, the networked sensor is an environmental sensor installed in a location associated with the user. In a further embodiment, the location associated with the user is the location of the user. In another embodiment, the location associated with the user is a destination of the user. In an embodiment, the networked sensor is a personal sensor of another user.

At block 404, the sensor data is used to construct a comfort state of a user of the wearable system. In an embodiment, using the sensor data to construct the comfort state comprises obtaining a biometric value from the sensor data and comparing the biometric value to a previously-obtained biometric value of the user. In a further embodiment, the biometric value is one of: a heart rate, a skin temperature, or a skin perspiration level.

At block 406, a context of the comfort state is determined. In an embodiment, determining the context of the comfort state comprises using sensor data to obtain an ambient measurement. In further embodiments, the ambient measurement is one of: an ambient temperature, an ambient noise level, or an ambient humidity.

In an embodiment, determining the context of the comfort state comprises obtaining a location of the user from the sensor data and determining the context from the location.

In an embodiment, determining the context of the comfort state comprises accessing a calendar of the user and determining the context from the calendar.

At block 408, a comfort model of the user is accessed, the comfort model reflecting target comfort states for associated contexts. In an embodiment, accessing the comfort model of the user comprises accessing the comfort model from a networked storage location.

At block 410, actuators in the wearable system are initiated based on the comfort model, the comfort state, and the context of the comfort state. In an embodiment, initiating actuators in the wearable system based on the comfort model, the comfort state, and the context of the comfort state comprises initiating actuators using predictive modeling on the comfort model.

In embodiments, initiating actuators in the wearable system based on the comfort model, the comfort state, and the context of the comfort state comprises initiating one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction.

In an embodiment, the method 400 includes presenting a user interface to the user and receiving responsive input from the user. In an embodiment, the responsive input is used to manually modify a setting of the wearable system. In an embodiment, the responsive input comprises feedback, the feedback used to modify the comfort model.

In an embodiment, the responsive input comprises user state information. In a further embodiment, the user state information includes a user health indication, a user activity indication, or a user location indication.

In an embodiment, the responsive input is provided by the user via an implicit indication or an explicit indication. In a further embodiment, the explicit indication is one of: an active gesture, an activation of a user interface control, or a verbal command.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

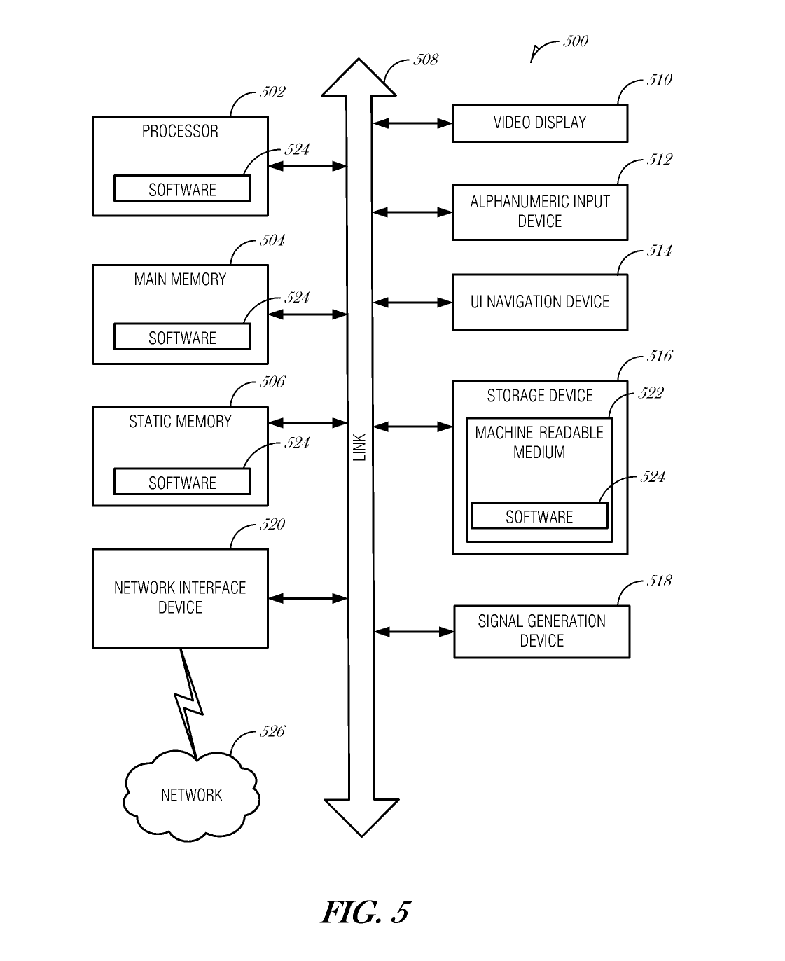

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, set-top box, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 includes subject matter for implementing smart clothing (such as a device, apparatus, or machine) comprising: a sensor module to receive sensor data from a sensor of the wearable system; a state module to use the sensor data to construct a comfort state of a user of the wearable system; a context module to determine a context of the comfort state; an access module to access a comfort model of the user, the comfort model reflecting target comfort states for associated contexts; and an actuation module to initiate actuators in the wearable system based on the comfort model, the comfort state, and the context of the comfort state.

In Example 2, the subject matter of Example 1 may include, wherein to receive sensor data, the sensor module is to: access a sensor integrated into the wearable system; and obtain the sensor data from the sensor integrated into the wearable system.

In Example 3, the subject matter of any one of Examples 1 to 2 may include, wherein to receive sensor data, the sensor module is to: access a networked sensor; and obtain the sensor data from the networked sensor.

In Example 4, the subject matter of any one of Examples 1 to 3 may include, wherein the networked sensor is provided by a cloud-based service.

In Example 5, the subject matter of any one of Examples 1 to 4 may include, wherein the networked sensor is an environmental sensor installed in a location associated with the user.

In Example 6, the subject matter of any one of Examples 1 to 5 may include, wherein the location associated with the user is the location of the user.

In Example 7, the subject matter of any one of Examples 1 to 6 may include, wherein the location associated with the user is a destination of the user.

In Example 8, the subject matter of any one of Examples 1 to 7 may include, wherein the networked sensor is a personal sensor of another user.

In Example 9, the subject matter of any one of Examples 1 to 8 may include, wherein to use the sensor data to construct the comfort state, the state module is to: obtain a biometric value from the sensor data; and compare the biometric value to a previously-obtained biometric value of the user.

In Example 10, the subject matter of any one of Examples 1 to 9 may include, wherein the biometric value is one of: a heart rate, a skin temperature, or a skin perspiration level.

In Example 11, the subject matter of any one of Examples 1 to 10 may include, wherein to determine the context of the comfort state, the context module is to: use sensor data to obtain an ambient measurement.

In Example 12, the subject matter of any one of Examples 1 to 11 may include, wherein the ambient measurement is one of: an ambient temperature, an ambient noise level, or an ambient humidity.

In Example 13, the subject matter of any one of Examples 1 to 12 may include, wherein to determine the context of the comfort state, the context module is to: obtain a location of the user from the sensor data; and determine the context from the location.

In Example 14, the subject matter of any one of Examples 1 to 13 may include, wherein to determine the context of the comfort state, the context module is to: access a calendar of the user; and determine the context from the calendar.

In Example 15, the subject matter of any one of Examples 1 to 14 may include, wherein to access the comfort model of the user, the access module is to: access the comfort model from a networked storage location.

In Example 16, the subject matter of any one of Examples 1 to 15 may include, wherein to initiate actuators in the wearable system based on the comfort model, the comfort state, and the context of the comfort state, the actuation module is to: initiate actuators using predictive modeling on the comfort model.

In Example 17, the subject matter of any one of Examples 1 to 16 may include, wherein to initiate actuators in the wearable system based on the comfort model, the comfort state, and the context of the comfort state, the actuation module is to: initiate one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction.

In Example 18, the subject matter of any one of Examples 1 to 17 may include a user interface module to: present a user interface to the user; and receive responsive input from the user.

In Example 19, the subject matter of any one of Examples 1 to 18 may include, wherein the responsive input is used to manually modify a setting of the wearable system.

In Example 20, the subject matter of any one of Examples 1 to 19 may include, wherein the responsive input comprises feedback, the feedback used to modify the comfort model.

In Example 21, the subject matter of any one of Examples 1 to 20 may include, wherein the responsive input comprises user state information.

In Example 22, the subject matter of any one of Examples 1 to 21 may include, wherein the user state information includes a user health indication, a user activity indication, or a user location indication.

In Example 23, the subject matter of any one of Examples 1 to 22 may include, wherein the responsive input is provided by the user via an implicit indication or an explicit indication.

In Example 24, the subject matter of any one of Examples 1 to 23 may include, wherein the explicit indication is one of: an active gesture, an activation of a user interface control, or a verbal command.

Example 25 includes subject matter for implementing smart clothing (such as a method, means for performing acts, machine readable medium including instructions that when performed by a machine cause the machine to performs acts, or an apparatus to perform) comprising: receiving sensor data at a clothing control module of a wearable system; using the sensor data to construct a comfort state of a user of the wearable system; determining a context of the comfort state; accessing a comfort model of the user, the comfort model reflecting target comfort states for associated contexts; and initiating actuators in the wearable system based on the comfort model, the comfort state, and the context of the comfort state.

In Example 26, the subject matter of Example 25 may include, wherein receiving sensor data comprises: accessing a sensor integrated into the wearable system; and obtaining the sensor data from the sensor integrated into the wearable system.

In Example 27, the subject matter of any one of Examples 25 to 26 may include, wherein receiving sensor data comprises: accessing a networked sensor; and obtaining the sensor data from the networked sensor.

In Example 28, the subject matter of any one of Examples 25 to 27 may include, wherein the networked sensor is provided by a cloud-based service.

In Example 29, the subject matter of any one of Examples 25 to 28 may include, wherein the networked sensor is an environmental sensor installed in a location associated with the user.

In Example 30, the subject matter of any one of Examples 25 to 29 may include, wherein the location associated with the user is the location of the user.

In Example 31, the subject matter of any one of Examples 25 to 30 may include, wherein the location associated with the user is a destination of the user.

In Example 32, the subject matter of any one of Examples 25 to 31 may include, wherein the networked sensor is a personal sensor of another user.

In Example 33, the subject matter of any one of Examples 25 to 32 may include, wherein using the sensor data to construct the comfort state comprises: obtaining a biometric value from the sensor data; and comparing the biometric value to a previously-obtained biometric value of the user.

In Example 34, the subject matter of any one of Examples 25 to 33 may include, wherein the biometric value is one of: a heart rate, a skin temperature, or a skin perspiration level.

In Example 35, the subject matter of any one of Examples 25 to 34 may include, wherein determining the context of the comfort state comprises: using sensor data to obtain an ambient measurement.

In Example 36, the subject matter of any one of Examples 25 to 35 may include, wherein the ambient measurement is one of: an ambient temperature, an ambient noise level, or an ambient humidity.

In Example 37, the subject matter of any one of Examples 25 to 36 may include, wherein determining the context of the comfort state comprises: obtaining a location of the user from the sensor data; and determining the context from the location.

In Example 38, the subject matter of any one of Examples 25 to 37 may include, wherein determining the context of the comfort state comprises: accessing a calendar of the user; and determining the context from the calendar.

In Example 39, the subject matter of any one of Examples 25 to 38 may include, wherein accessing the comfort model of the user comprises: accessing the comfort model from a networked storage location.

In Example 40, the subject matter of any one of Examples 25 to 39 may include, wherein initiating actuators in the wearable system based on the comfort model, the comfort state, and the context of the comfort state comprises: initiating actuators using predictive modeling on the comfort model.

In Example 41, the subject matter of any one of Examples 25 to 40 may include, wherein initiating actuators in the wearable system based on the comfort model, the comfort state, and the context of the comfort state comprises: initiating one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction.

In Example 42, the subject matter of any one of Examples 25 to 41 may include, presenting a user interface to the user; and receiving responsive input from the user.

In Example 43, the subject matter of any one of Examples 25 to 42 may include, wherein the responsive input is used to manually modify a setting of the wearable system.

In Example 44, the subject matter of any one of Examples 25 to 43 may include, wherein the responsive input comprises feedback, the feedback used to modify the comfort model.

In Example 45, the subject matter of any one of Examples 25 to 44 may include, wherein the responsive input comprises user state information.

In Example 46, the subject matter of any one of Examples 25 to 45 may include, wherein the user state information includes a user health indication, a user activity indication, or a user location indication.

In Example 47, the subject matter of any one of Examples 25 to 46 may include, wherein the responsive input is provided by the user via an implicit indication or an explicit indication.

In Example 48, the subject matter of any one of Examples 25 to 47 may include, wherein the explicit indication is one of: an active gesture, an activation of a user interface control, or a verbal command.

Example 49 includes at least one machine-readable medium including instruction, which when executed by a machine cause the machine to perform operations of any of the Examples 25-48.

Example 50 includes an apparatus comprising means for performing any of the Examples 25-48.

Example 51 includes subject matter for implementing smart clothing (such as a device, apparatus, or machine) comprising: means for receiving sensor data at a clothing control module of a wearable system; means for using the sensor data to construct a comfort state of a user of the wearable system; means for determining a context of the comfort state; means for accessing a comfort model of the user, the comfort model reflecting target comfort states for associated contexts; and means for initiating actuators in the wearable system based on the comfort model, the comfort state, and the context of the comfort state.

In Example 52, the subject matter of Example 51 may include, wherein the means for receiving sensor data comprises: means for accessing a sensor integrated into the wearable system; and means for obtaining the sensor data from the sensor integrated into the wearable system.

In Example 53, the subject matter of any one of Examples 51 to 52 may include, wherein the means for receiving sensor data comprises: means for accessing a networked sensor; and means for obtaining the sensor data from the networked sensor.

In Example 54, the subject matter of any one of Examples 51 to 53 may include, wherein the networked sensor is provided by a cloud-based service.

In Example 55, the subject matter of any one of Examples 51 to 54 may include, wherein the networked sensor is an environmental sensor installed in a location associated with the user.

In Example 56, the subject matter of any one of Examples 51 to 55 may include, wherein the location associated with the user is the location of the user.

In Example 57, the subject matter of any one of Examples 51 to 56 may include, wherein the location associated with the user is a destination of the user.

In Example 58, the subject matter of any one of Examples 51 to 57 may include, wherein the networked sensor is a personal sensor of another user.

In Example 59, the subject matter of any one of Examples 51 to 58 may include, wherein the means for using the sensor data to construct the comfort state comprises: means for obtaining a biometric value from the sensor data; and means for comparing the biometric value to a previously-obtained biometric value of the user.

In Example 60, the subject matter of any one of Examples 51 to 59 may include, wherein the biometric value is one of: a heart rate, a skin temperature, or a skin perspiration level.

In Example 61, the subject matter of any one of Examples 51 to 60 may include, wherein the means for determining the context of the comfort state comprises: means for using sensor data to obtain an ambient measurement.

In Example 62, the subject matter of any one of Examples 51 to 61 may include, wherein the ambient measurement is one of: an ambient temperature, an ambient noise level, or an ambient humidity.

In Example 63, the subject matter of any one of Examples 51 to 62 may include, wherein the means for determining the context of the comfort state comprises: means for obtaining a location of the user from the sensor data; and means for determining the context from the location.

In Example 64, the subject matter of any one of Examples 51 to 63 may include, wherein the means for determining the context of the comfort state comprises: means for accessing a calendar of the user; and means for determining the context from the calendar.

In Example 65, the subject matter of any one of Examples 51 to 64 may include, wherein the means for accessing the comfort model of the user comprises: means for accessing the comfort model from a networked storage location.

In Example 66, the subject matter of any one of Examples 51 to 65 may include, wherein the means for initiating actuators in the wearable system based on the comfort model, the comfort state, and the context of the comfort state comprises: means for initiating actuators using predictive modeling on the comfort model.

In Example 67, the subject matter of any one of Examples 51 to 66 may include, wherein the means for initiating actuators in the wearable system based on the comfort model, the comfort state, and the context of the comfort state comprises: means for initiating one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction.

In Example 68, the subject matter of any one of Examples 51 to 67 may include, means for presenting a user interface to the user; and means for receiving responsive input from the user.

In Example 69, the subject matter of any one of Examples 51 to 68 may include, wherein the responsive input is used to manually modify a setting of the wearable system.

In Example 70, the subject matter of any one of Examples 51 to 69 may include, wherein the responsive input comprises feedback, the feedback used to modify the comfort model.

In Example 71, the subject matter of any one of Examples 51 to 70 may include, wherein the responsive input comprises user state information.

In Example 72, the subject matter of any one of Examples 51 to 71 may include, wherein the user state information includes a user health indication, a user activity indication, or a user location indication.

In Example 73, the subject matter of any one of Examples 51 to 72 may include, wherein the responsive input is provided by the user via an implicit indication or an explicit indication.

In Example 74, the subject matter of any one of Examples 51 to 73 may include, wherein the explicit indication is one of: an active gesture, an activation of a user interface control, or a verbal command.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A wearable system for implementing smart clothing, the system comprising:
a sensor module to receive sensor data from a sensor of the wearable system;
a state module to use the sensor data to construct a comfort state of a user of the wearable system;
a context module to determine a context of the comfort state;
an access module to access a comfort model of the user, the comfort model reflecting target comfort states for associated contexts; and
an actuation module to initiate actuators in the wearable system based on the comfort model, the comfort state, and the context of the comfort state.

2. The system of claim 1, wherein to receive sensor data, the sensor module is to:
access a sensor integrated into the wearable system; and
obtain the sensor data from the sensor integrated into the wearable system.

3. The system of claim 1, wherein to receive sensor data, the sensor module is to:
access a networked sensor; and
obtain the sensor data from the networked sensor.

4. The system of claim 3, wherein the networked sensor is provided by a cloud-based service.

5. The system of claim 3, wherein the networked sensor is an environmental sensor installed in a location associated with the user.

6. The system of claim 5, wherein the location associated with the user is the location of the user.

7. The system of claim 5, wherein the location associated with the user is a destination of the user.

8. The system of claim 3, wherein the networked sensor is a personal sensor of another user.

9. The system of claim 1, wherein to use the sensor data to construct the comfort state, the state module is to:
obtain a biometric value from the sensor data; and
compare the biometric value to a previously-obtained biometric value of the user.

10. The system of claim 9, wherein the biometric value is one of: a heart rate, a skin temperature, or a skin perspiration level.

11. The system of claim 1, wherein to determine the context of the comfort state, the context module is to:
use sensor data to obtain an ambient measurement.

12. The system of claim 11, wherein the ambient measurement is one of: an ambient temperature, an ambient noise level, or an ambient humidity.

13. The system of claim 1, wherein to determine the context of the comfort state, the context module is to:
obtain a location of the user from the sensor data; and
determine the context from the location.

14. The system of claim 1, wherein to determine the context of the comfort state, the context module is to:
access a calendar of the user; and
determine the context from the calendar.

15. A method of implementing smart clothing, the method comprising:
receiving sensor data at a clothing control module of a wearable system;
using the sensor data to construct a comfort state of a user of the wearable system;
determining a context of the comfort state;
accessing a comfort model of the user, the comfort model reflecting target comfort states for associated contexts; and
initiating actuators in the wearable system based on the comfort model, the comfort state, and the context of the comfort state.

16. The method of claim 15, wherein accessing the comfort model of the user comprises:
accessing the comfort model from a networked storage location.

17. The method of claim 15, wherein initiating actuators in the wearable system based on the comfort model, the comfort state, and the context of the comfort state comprises:
initiating actuators using predictive modeling on the comfort model.

18. The method of claim 15, wherein initiating actuators in the wearable system based on the comfort model, the comfort state, and the context of the comfort state comprises:
initiating one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction.

19. The method of claim 15, further comprising:
presenting a user interface to the user; and
receiving responsive input from the user.

20. The method of claim 19, wherein the responsive input is used to manually modify a setting of the wearable system.

21. At least one machine-readable medium including instructions, which when executed by a machine cause the machine to:
receive sensor data at a clothing control module of a wearable system;
use the sensor data to construct a comfort state of a user of the wearable system;
determine a context of the comfort state;
access a comfort model of the user, the comfort model reflecting target comfort states for associated contexts; and
initiate actuators in the wearable system based on the comfort model, the comfort state, and the context of the comfort state.

22. The at least one machine-readable medium of claim 21, wherein the instructions to access the comfort model of the user comprise instructions to:
access the comfort model from a networked storage location.

23. The at least one machine-readable medium of claim 21, wherein the instructions to initiate actuators in the wearable system based on the comfort model, the comfort state, and the context of the comfort state comprise instructions to:
initiate actuators using predictive modeling on the comfort model.

24. The at least one machine-readable medium of claim 21, wherein the instructions to initiate actuators in the wearable system based on the comfort model, the comfort state, and the context of the comfort state comprise instructions to:
initiate one of: a mechanism to open or close a vent in the wearable system, a mechanism to tighten or loosen a portion of the wearable system, a mechanism to increase or decrease airflow in or through the wearable system, a mechanism to increase or decrease a length of a portion of the wearable system, a mechanism to initiate a chemical reaction.

25. The at least one machine-readable medium of claim 21, further comprising instructions to:
present a user interface to the user; and
receive responsive input from the user, wherein the responsive input is used to manually modify a setting of the wearable system.
